(19) United States
(12) Patent Application Publication
(10) Pub. No.: US 2017/0328518 A1
(43) Pub. Date: Nov. 16, 2017

(54) Compressed Gas Container

(71) Applicant: Daimler AG, Muenchen (DE)

(72) Inventors: Sven PEGEL, Ostfildern (DE); Rafael EISENER, Stuttgart (DE)

(73) Assignee: Daimler AG, Muenchen (DE)

(21) Appl. No.: 15/523,189

(22) PCT Filed: Sep. 16, 2015
(86) PCT No.: PCT/EP2015/001852

§ 371 Date: Apr. 28, 2017

(30) Foreign Application Priority Data
Oct. 29, 2014 (DE) 10 2014 016 023.8

(51) Int. Cl. F17C 1/16; B29C 53/56; B29B 15/10; B29K 75/00; B29L 31/00; B29K 105/08

(52) U.S. Cl. CPC F17C 1/16; B29C 53/56; B29B 15/10; F17C 2221/012; F17C 2209/232; F17C 2209/2163; F17C 2205/0305; F17C 2203/0675; F17C 2203/0673; F17C 2203/0665; F17C 2203/066; F17C 2203/0624; F17C 2203/012; F17C 2201/0109; B29L 2031/712; B29K 2105/08; B29K 2075/00; F17C 2221/033; F17C 2270/0168; F17C 2260/011

(57) ABSTRACT

A compressed gas container is disclosed. The compressed gas container has a single one-piece casing surrounding a storage volume and includes a matrix material and reinforcing fibers. The composition of the matrix material between the region of the single one-piece casing facing the storage volume and the region of the single one-piece casing facing the surroundings of the single one-piece casing changes at least once. A method for manufacturing a compressed gas container is also disclosed.

### BACKGROUND AND SUMMARY OF THE INVENTION

The invention relates to a compressed gas container. In addition, the invention relates to a method for manufacturing a compressed gas container. Finally, the invention relates to the use of a compressed gas container according to the invention and to a compressed gas container manufactured by the method according to the invention.

Compressed gas containers, for example, for storing hydrogen or compressed natural gas, in particular, in vehicles, are known in the general state of the art. The current latest state of the art in this case is defined by a so-called type IV pressure vessel, which consists of a metallic connection element, an inner casing, the so-called inner liner, made of plastic, as well as an outer jacket made of fiber-reinforced plastic, typically of carbon fibers and a bonding matrix. This structure allows high pressures of, for example, 70 MPa nominal pressure in the case of hydrogen. The disadvantage of these structures is that a compressed gas container of this type is subject to high thermal and mechanical loads during subsequent operation, in particular when filled with hydrogen. One problem that occurs in this case, in particular also because the inner liner can never be designed to be sealed 100 percent against the diffusion of hydrogen, is that hydrogen penetrates through the inner liner and bubbles form between the inner liner and the casing made of the fiber-reinforced plastic. This is highly undesirable, since it reduces the available storage volume in particular. Moreover, when the vessel is refilled with hydrogen, plastic material may be forced through the casing made of fiber-reinforced plastic material by the continually enlarging inner liner, so that hydrogen escapes into the environment and, for example, triggers an alarm and/or a safety-critical hydrogen/oxygen mixture forms.

Such a type-IV pressure vessel is described, for example, in DE 10 2010 033 623 A1 The pressure vessel described therein has a particular structure, in which the inner liner consists of multiple layers of different plastics which, however, makes the compressed gas container extremely costly to manufacture.

In general, the inner liner not only serves to encase the gas to be stored in a diffusion-resistant manner, but may also be used as a mold for winding or weaving the casing made of fiber-reinforced plastic. In alternative manufacturing methods, this is dispensed with and a lost core is inserted. Thus, a compressed gas container is described in US 2013/0105501 A1, in which a plastic film for forming the inner liner is first wound on a lost core before this layer is surrounded by a fiber-reinforced matrix as a mechanical support layer. The alternative structure having a wound inner layer, i.e., a type of wound inner liner notwithstanding, this too is a type-IV pressure vessel, which ultimately also has the disadvantages cited above. The document states that in this way the wound inner liner can be designed with a particularly tight seal, but for physical reasons alone, this is never 100 percent successful when storing hydrogen, so that this structure as well exhibits the cited disadvantages.

The object of the present invention then is to specify a compressed gas container and a method for the manufacture thereof, which are an improvement over the prior art and which, in particular, avoid the disadvantages cited above.

The compressed gas container according to the invention, like the compressed gas container in the prior art, has a casing surrounding a storage volume, which includes a matrix and reinforcing fibers. According to the invention, however, a liner is dispensed with. Instead, in the compressed gas container according to the invention, the composition of the matrix between the region of the casing facing the storage volume and the region of the casing facing the surroundings of the casing changes at least once. As a result, different properties of the matrix can be implemented in one single casing. This makes it possible to dispense with the liner and thus to circumvent the problems and disadvantages typically accompanying the inner liner. According to the previously applied nomenclature, such a compressed gas container could also be referred to as a type-IV compressed gas container. It is made of a single casing, which combines all necessary properties in one single casing through at least a one-time change in the composition of the matrix over the thickness of the casing.

According to one advantageous refinement of the compressed gas container according to the invention, it is provided that the matrix is optimally formed with respect to a diffusion sealing in the region facing the storage volume against the gas to be stored and with respect to the mechanical bonding properties of the fibers through the matrix in the region facing the surroundings. Thus, the material of the matrix surrounding the reinforcing fibers is formed with a particularly tight seal in the inner region, in the region facing the storage volume, and has especially good mechanical properties in the outer region, i.e., in the region facing the surroundings, in order to ensure a safe and reliable bonding of the fibers to one another, wherein the seal against the gas can be disregarded because the gas can be detained as much as possible by the region situated further inward which, as one of the physical possibilities, is maximally diffusion-resistant. Such a compressed gas container can be manufactured at a very minimal cost because the complicated manufacture of the liner can be dispensed with. By omitting the liner, corresponding weak points, such as the formation of gas bubbles between the liner and the outer casing are also consistently avoided, since the layer of the matrix that supplies the diffusion sealing is permanently bonded to the overlying layers of the matrix and to the fibers extending through both layers, so that a very compact and mechanically reliable structure is formed. As a result, the structure enables an increased long-term stability. It also allows for a much more flexible manufacture of the compressed gas container than is the case with previous structures, since by dispensing with the inner lining, which is costly to manufacture anyway, complex tank shapes become very easily possible, for example, tubular tank designs, curved tank designs and the like. These can be optimally integrated in existing installation spaces, for example, in vehicles.

According to one advantageous refinement of the idea, carbon fibers may be used as reinforcing fibers. According to another very advantageous embodiment of the idea, the matrix may be formed based on polyurethane in its region facing the storage volume. Such a polyurethane, in particular, a thermoplastic polyurethane, which cures accordingly during the manufacture of the fiber-reinforced casing, exhibits the highest sealing properties even against critical gases such as, for example, hydrogen, which is easily volatile. The use of such polyurethanes is therefore particularly advantageous in the compressed gas container according to the invention.

Another very favorable embodiment of the compressed gas container according to the invention provides that the casing also includes a metal connection element, with which the casing is securely connected. Such a metal connection element, also referred to as a boss, may therefore be directly integrated, as in conventional compressed gas containers, in particular, by connecting this to the single casing. According to a very advantageous refinement of this idea, it may be provided in this case that mechanical retaining structures and/or a coating for improving adhesion to the connection element are provided in the region in contact with the casing. Such a coating, in particular, in combination with a mechanical roughening, for example, the provision of nubs or the like, enable an ideal adhesion, since this adhesion can be formed, on the one hand chemically with the matrix and on the other hand by a mechanical form-locking connection with the reinforcing fibers, which can be inserted, for example, woven into the structures if these are present, or wound in between them.

The method for manufacturing a compressed gas container according to the invention having a storage volume surrounded by a casing provides that the casing is formed from reinforcing fibers and at least one cured matrix material. According to the invention, the method provides that the reinforcing fibers are impregnated with the uncured matrix material and are directly wound and/or woven around a lost core and a connecting area of a connection element, wherein the composition of the matrix material is changed at least once as the thickness of the casing is increased. In this way, it is possible to manufacture such a vessel very easily and efficiently and very flexibly with respect to the shape of what is later the compressed gas container. By changing the composition of the matrix material across the thickness of the casing, it is possible to very easily and efficiently obtain, in particular, the properties in the compressed gas container according to the invention already described above.

In one advantageous refinement of the method according to the invention, it can be further provided that the different composition of the matrix material is obtained by a variation of the ratio of the otherwise identical starting materials for the matrix. In particular, the same starting materials for manufacturing the matrix can be used over the entire thickness of the easing. This makes the structure particularly simple and efficient during manufacturing. Thus, for example, resin systems based on isocyanates and polyolenes may be used for a polyurethane matrix. These are blended in a continuous process during wetting or just prior to wetting of the reinforcing fibers. By selecting the ratio of components during blending, it is possible to adjust the physical properties of the resin system within a comparatively wide range. By specifically controlling the mixing of the matrix components, i.e., the ratio of the starting materials to one another, it is possible in this way to achieve a specific variation of the properties of the casing during the winding or weaving around the lost core, it is possible, in particular, to optimize the inner layers with respect to their barrier properties, i.e., in particular, with respect to the diffusion sealing against the later to be stored gas. The outer layers may be optimized with. respect to their mechanical properties, i.e., in such a way that the fibers are particularly firmly bonded to one another and therefore a very good and reliable mechanical structure is formed, which has a high load capacity.

As previously indicated above, a compressed gas container according to the invention or a compressed gas container manufactured by the method according to the invention can be manufactured, in particular, both highly flexibly with respect to its shape and also very cost-effectively and at the same time reliably and safely. This makes the compressed gas container according to the invention or the compressed gas container manufactured by the method according to the invention particularly suitable for applications in high volumes, i.e., in particular, storage applications in vehicles driven by hydrogen or compressed natural gas. The high reliability and safety plays a decisive role, in particular, in such applications. At the same time a further important advantage results in that the shape of the vessel may be very flexibly adapted. As a result, existing hollow spaces in the vehicle may be utilized in an installation space-optimizing manner, resulting in an increase in the range of the vehicle by the compressed gas container according to the invention or by a compressed gas container manufactured by the method according to the invention. Thus, the particularly preferred use of the compressed gas container according to the invention or of a compressed gas container manufactured by the method according to the invention is its application in a vehicle, in which it stores gaseous fuel.

Additional advantageous embodiments of the compressed gas container according to the invention as well as its method of manufacture also result from the exemplary embodiment, which is described below with reference to the figures.

### BRIEF DESCRIPTION OF THE DRAWINGS

FIG. 1 shows an exploded view of a detail of a compressed gas container;

FIG. 2 shows a first highly schematized manufacturing step of the manufacturing method according to the invention; and

FIG. 3 shows a second highly schematized manufacturing step of the manufacturing method according to the invention.

### DETAILED DESCRIPTION OF THE DRAWINGS

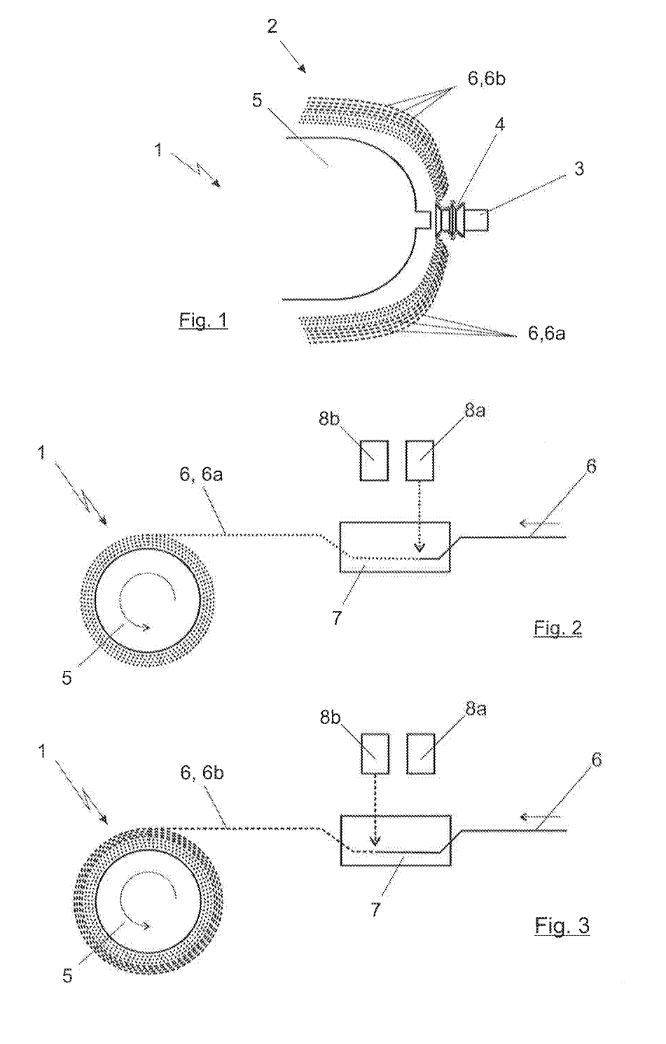

A detail of a compressed gas container I in an exploded view is apparent in the representation of FIG. 1. The compressed gas container 1 in this case is formed from a casing 2 and from a connection element, the so-called boss 3. In addition, a bonding agent 4 is indicated by dot-dashed lines on the periphery of the connection element 3, in which this element will be later connected to the casing 2. The boss 3 is attached to a lost mold 5 made, for example, of Styrofoam. Together with this lost form 5, the boss is subsequently surrounded by the casing 2. The casing 2 comprises reinforcing fibers 6, in particular, carbon fibers, These fibers are indicated in the representation of FIG. 1 and provided in part with the reference numeral 6. They surround what is later a storage volume, which replaces the lost mold 5 when the latter is correspondingly removed, for example, flushed out of what is later the compressed gas container 2 by dissolution with a chemical solvent. The reinforcing fibers 6 facing what is later the storage volume or the lost mold 5 are represented by dots in the representation of FIG. 1. These fibers subsequently identified by 6a are bonded to one another via a first matrix material, which will be discussed in detail below. The additional reinforcing fibers 6 situated facing away from the lost mold 5 or the storage volume, i.e., which face the surroundings of what is later the compressed gas container 1, are represented by dashed lines in the representation of FIG. 1 and identified by 6b. These are the same fibers 6, but they are provided with a different matrix material.

The manufacture of the compressed gas container 1 is exemplarily indicated in FIGS. 2 and 3 by way of example of a structure of the casing 2 made of wound reinforcing fibers 6. The structure could just as well be implemented with woven fibers 6 or with a combination of wound and woven fibers 6, for example, alternating in layers.

In the representation of FIG. 2, the reinforcing fibers 6 to the right are represented as a solid line, it passes through an apparatus 7, in which it is impregnated with the matrix material. In the exemplary representation, two supply containers 8a, 8b for the matrix material are apparent. The impregnation of the fibers 6 with the matrix material from the supply container 8a takes place in the representation of FIG. 2, which shows the winding of the inner layers on the lost mold 5, i.e., what are later the layers facing the storage volume. This matrix material, once cured, ensures a matrix having properties which make these ideal as a diffusion barrier or permeation barrier against the gas to be stored later in the compressed gas container 1. Further on, the now impregnated fibers 6 are represented by dots as in the representation of FIG. 1, and are identified by 6a as a result of being impregnated with the matrix material from the supply container 8a. The fibers 6a in this example are wound on the lost, core 5 and form the inner layers, which on the one hand exhibit proper mechanical properties due to the matrix and the reinforcing fibers 6, and which on the other hand have very good properties for forming the desired diffusion barrier or permeation barrier as a result of the impregnation of the reinforcing fibers 6 with the matrix material from the supply container 8a.

The further course of the manufacturing process is apparent in the representation of FIG. 3. The same fiber 6, in turn, is fed to the apparatus 7. At this point, the fiber 6 is impregnated with the matrix material from the supply container 8b. The impregnated fiber 6 is subsequently identified by 6b and represented by dashed lines as in the representation of FIG. 1. This fiber 6b is then wound on the lost core 5 in the further outer lying profile of the casing 2. The matrix material stocked in the supply container 8b may then be formed, in particular, in such a way that here the permeation resistance or diffusion resistance plays a subordinate role, whereas the mechanical properties are preferred with respect to a reliable bonding of the individual fibers 6. This results in an overall structure of a single one-piece casing 2, which exhibits properties in its inner region facing the storage volume or the lost core 5 that differ from those in the outer region. This makes it possible to simply and efficiently implement both the functionality of the diffusion scaling as well as the mechanical load capacity of the compressed gas container 1.

In addition to the use described herein of two different matrix materials in the supply containers 8a, 8b, it would of course also be conceivable and possible to use the same starting materials for the matrix, which are mixed in different ratios. Such a structure allows, in particular, a continuous change of properties, i.e., a continuous transition of the mixing ratio of the matrix material from the inside of the casing 2 to its outer side, so that a greater stability and an improved mechanical strength of the casing 2 may be achieved by foregoing the sudden change of properties.

1.-10. (canceled)

11. A compressed gas container, comprising:
a single one-piece casing, wherein the single one-piece casing surrounds a storage volume and wherein the single one-piece casing includes a matrix material and reinforcing fibers;
wherein a composition of the matrix material between a first region of the single one-piece casing facing the storage volume and a second region of the single one-piece casing facing surroundings of the single one-piece casing changes at least once.

12. The compressed gas container according to claim 11, wherein the matrix material is optimized with respect to a diffusion sealing in the first region facing the storage volume and optimized with respect to mechanical properties in the second region facing the surroundings.

13. The compressed gas container according to claim 11, wherein the reinforcing fibers include carbon fibers.

14. The compressed gas container according to claim 11, wherein the matrix material includes polyurethane at least in the first region facing the storage volume.

15. The compressed gas container according to claim 11, wherein the single one-piece casing is securely connected to a connection element.

16. The compressed gas container according to claim 15, wherein the connection element includes a mechanical retaining structure and/or a coating in a region in contact with the single one-piece casing.

17. A method for manufacturing a compressed gas container having a storage volume surrounded by a single one-piece casing, wherein the single one-piece casing is formed from reinforcing fibers and a matrix material, comprising the steps of:
impregnating the reinforcing fibers with the matrix material and winding and/or weaving the impregnated reinforcing fibers around a core, wherein a composition of the matrix material is changed at least once during the impregnating and winding and/or weaving.

18. The method according to claim 17, wherein the changed composition of the matrix material is obtained by varying a ratio of identical starting materials of the matrix material.

19. The method according to claim 17, wherein the matrix material is optimized with respect to a diffusion sealing in a first region facing the storage volume and optimized with respect to mechanical properties in a second region facing surroundings.

20. A method for use of a compressed gas container in a vehicle, wherein the compressed gas container comprises:
a single one-piece casing, wherein the single one-piece casing surrounds a storage volume and wherein the single one-piece casing includes a matrix material and reinforcing fibers;
wherein a composition of the matrix material between a first region of the single one-piece casing facing the storage volume and a second region of the single one-piece casing facing surroundings of the single one-piece casing changes at least once;
and comprising the step of:
storing a gaseous fuel in the compressed gas container.

21. The method according to claim 20, wherein the gaseous fuel is hydrogen.
